(19) United States
(12) Patent Application Publication
(10) Pub. No.: US 2013/0115341 A1
(43) Pub. Date: May 9, 2013

(54) METHOD AND SYSTEM FOR THE PRESERVATION AND REGENERATION OF PRE-BAKED BREAD

(71) Applicants: XAVIER PUJOL FORNOS, Barcelona (ES); Susana Batres Gonzalez, Barcelona (ES); Miquel Codina Giro, Barcelona (ES)

(72) Inventors: XAVIER PUJOL FORNOS, Barcelona (ES); Susana Batres Gonzalez, Barcelona (ES); Miquel Codina Giro, Barcelona (ES)

(73) Assignee: BIMBO, S.A., Barcelona (ES)

(21) Appl. No.: 13/618,124

(22) Filed: Sep. 14, 2012

(30) Foreign Application Priority Data
Nov. 3, 2011 (ES) 201131756

(51) Int. Cl. B65D 81/24; A21D 17/00; A23L 3/10; A21D 15/00

(52) U.S. Cl. 426/124; 426/394; 426/396; 99/359; 99/331

(57) ABSTRACT

The present disclosure relates to a method and system for the preservation and regeneration of pre-baked bread. The method comprises a preservation phase including the steps of enclosing the pre-baked bread in a receptacle capable of withstanding high temperatures, and hermetically enclosing the receptacle in an atmosphere conducive to the preservation of the pre-baked bread. The method may further include the step of heating the receptacle containing the pre-baked bread. The system comprises a packaging for preservation of pre-baked bread, including a receptacle for containing the pre-baked bread, the receptacle being capable of withstanding high temperatures. The packaging also comprises an enclosure for hermetically enclosing the receptacle, the enclosure containing a gas conducive to the preservation of pre-baked bread, such as CO₂. The system may also include an oven configured to heat the receptacle and pre-baked bread at a temperature between about 100 degrees and 250 degrees Celsius.

### CROSS REFERENCE TO RELATED APPLICATIONS

This application claims benefit under 35 U.S.C. §119 of Spanish Patent Application No. 201131756 filed on Nov. 3, 2011 titled “METODO Y SISTEMA PARA LA CONSERVACION Y REGENERACION DE PAN PRECOCIDO.”

### TECHNICAL FIELD

The present disclosure relates to the field of bread production and distribution, and by extension to sweet bread, pastries and related products.

### BACKGROUND

It is well known that bread manufacture involves a series of steps including preparation of the dough, formation into unitary pieces, fermentation, and baking. These steps require a certain amount of time; consequently, there exists a trend in the baking industry to provide partially cooked bread, refrigerated or frozen, so that businesses are able to perform the final stage of baking in a relatively short time to prepare the bread for sale. In this manner, bread can be distributed from a production plant to various bakeries, restaurants, businesses or other possible outlets, which in turn can prepare quantities of bread as needed for sale or consumption, while keeping the remaining product refrigerated or frozen until it is needed.

However, when a customer purchases fresh bread, it naturally becomes hard or soggy over the course of a few hours, depending on environmental conditions, particularly the relative humidity of the air. These changes in the characteristics of the bread, especially in texture, result in the consumer being unable to enjoy the bread and perceiving the bread as of poor quality, unable to maintain optimal characteristics for a relatively short period of time.

### BRIEF SUMMARY

The present disclosure relates to a method and system for the preservation and regeneration of pre-baked bread. The method comprises a preservation phase including the steps of enclosing the pre-baked bread in a receptacle capable of withstanding high temperatures, and hermetically enclosing the receptacle in an enclosure containing an atmosphere conducive to the preservation of the pre-baked bread. The method may further include a regeneration phase comprising the steps of removing the receptacle containing the pre-baked bread from the enclosure, and heating the receptacle containing the pre-baked bread.

The system includes a packaging for preservation of pre-baked bread. The packaging includes a receptacle containing the pre-baked bread, the receptacle being capable of withstanding high temperatures. The receptacle may include at least one perforation to allow circulation of air. The packaging also comprises an enclosure for hermetically enclosing the receptacle, the enclosure containing a gas conducive to the preservation of pre-baked bread. The gas comprises at least 80% CO₂. The system may also include a regenerating over configured to receive the receptacle containing the pre-baked bread, and heating the receptacle at a temperature between about 100 degrees Celsius and about 250 degrees Celsius.

### BRIEF DESCRIPTION OF THE DRAWINGS

FIG. 1a shows the pre-baked bread being placed into a carton according to the present disclosure.

FIG. 1b shows the carton of FIG. 1a containing the pre-baked bread being placed into a bag according to the present disclosure.

FIG. 1c shows the bag of FIG. 1b hermetically sealed and enclosing the carton of FIG. 1a containing the pre-baked bread.

FIG. 2a shows the carton of FIG. 1a containing the pre-baked bread being removed from the bag of FIG. 1b.

FIG. 2b shows the carton of FIG. 1a containing the pre-baked bread being placed into an oven.

FIG. 2c shows a user heating the carton of FIG. 1a containing the pre-baked bread in the oven.

FIG. 2d shows the carton of FIG. 1a containing the pre-baked bread being removed from the oven.

FIG. 2e shows the pre-baked bread being removed from the carton for consumption.

FIG. 3a illustrates the steps of a preservation phase of a method for preservation and regeneration of pre-baked bread according to the present disclosure.

FIG. 3b illustrates the steps of a regeneration phase of a method for preservation and regeneration of pre-baked bread according to the present disclosure.

### DETAILED DESCRIPTION OF THE DRAWINGS AND PREFERRED EMBODIMENTS

In accordance with the present disclosure, a method for preserving and regenerating pre-baked bread includes: a) a preservation phase from the moment the bread is manufactured until final consumption; and b) a regeneration phase involving heating the bread, which allows it to acquire characteristics and texture very similar to those of freshly baked bread.

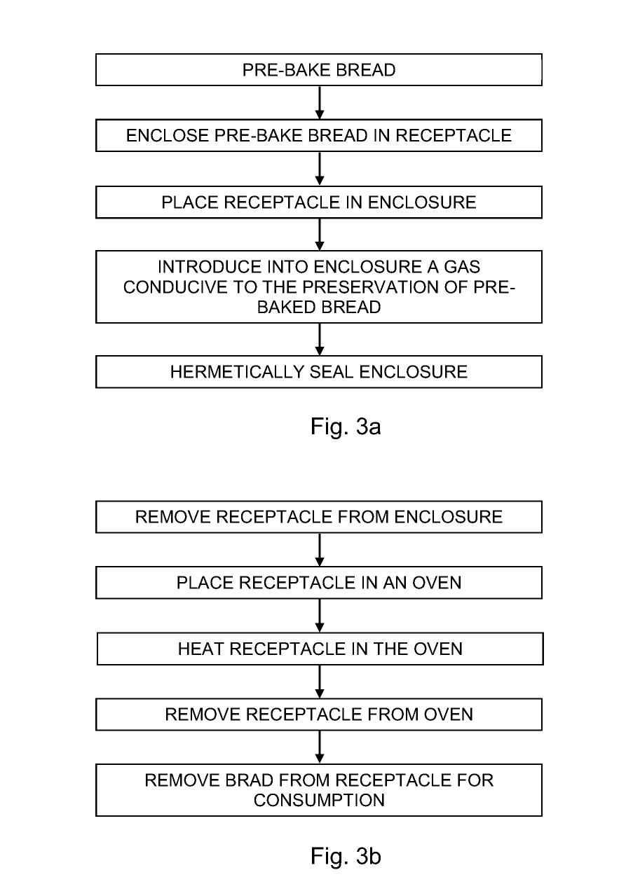

In an exemplary embodiment, the preservation phase may include the following steps, as shown in FIG. 3a: (1) manufacture of dough and baking of the dough to obtain a pre-baked bread; (2) placement of the pre-baked bread into a carton made of material resistant to high temperatures; (3) placement of the carton into a protective bag or wrapper made of plastic material; (4) creation of a preservative atmosphere within the bag by introducing a gas or gas mixture conducive to bread preservation; (5) hermetic closure and sealing of the bag for distribution and commercialization of the pre-baked bread.

In an exemplary embodiment, the preservative atmosphere may comprise 100% CO₂ or, alternatively, 80% CO₂ and 20% Nitrogen. One of the goals of the preservative atmosphere is to properly preserve the pre-baked bread until the moment of consumption. During the period of time between initial manufacture and consumption of the pre-baked bread, its freshness is maintained by the preservative atmosphere created inside the bag, which remains hermetically sealed.

In an exemplary embodiment, the regeneration phase to regenerate the bread for consumption may involve the following steps, as illustrated in FIG. 3b: (1) removal of the carton containing the pre-baked bread from the protective plastic bag or wrapper; (2) placement of the carton containing the pre-baked bread into a regenerating oven and heating at a temperature between about 100 and 250 degrees Celsius (between about 212 and 482 degrees Fahrenheit) for less than 7 minutes; and (3) removal of the bread from the carton for sale and consumption.

During the regeneration phase, the bread is heated by, for example, hot air convection and/or radiation, which results in recovery of the characteristics the bread possessed when freshly baked, so that the consumer eating the bread experiences a bread that tastes and feels as if it was just taken out of the oven. Other appropriate heat sources may also be used in the regeneration phase.

In addition, a system for preservation and regeneration of pre-baked bread in accordance with the method described above is disclosed. The system comprises a packaging to preserve the pre-baked bread until just moments before its consumption, and a heat source such as an oven to heat the bread just prior to consumption so that it acquires characteristics similar to those of freshly baked bread.

In an exemplary embodiment, the packaging includes a carton made of material resistant to high temperatures, which serves as a container for the bread to be preserved and later regenerated. The carton may include a number of perforations to allow air circulation in and out of the carton. The packaging may also include a protective bag or wrapper made of plastic material, which surrounds the carton and is hermetically sealed to form an enclosure for the bread to be contained in a modified atmosphere that preserves its freshness.

In an exemplary embodiment, the carton is made of virgin cardboard or specialized cardboard suitable for baking and that can be printed with ink. The cardboard may have characteristics that prevent, under varying thermal conditions, the seepage of ink through it, or the transfer of cardboard particles to the bread contained within. Materials other than cardboard that are suitable and capable of achieving these goals are also contemplated for the construction of the carton.

In a preferred embodiment, the carton is of a quadrangular shape, and the perforations are located on two opposite ends of the carton. The perforations may be large enough to also facilitate handling of the carton by a user. The protective bag or wrapper may include a barrier film made of polyester and/or polyethylene, depending on the desired film thickness or the type of material chosen for the bag.

The bread-regenerating oven may comprise heating means using air convection and/or radiation; means for mechanical detection and recognition of the size and/or shape of the carton; and control means for determining time and heating temperature parameters depending on the size and/or shape of the carton introduced in the bread-regenerating oven.

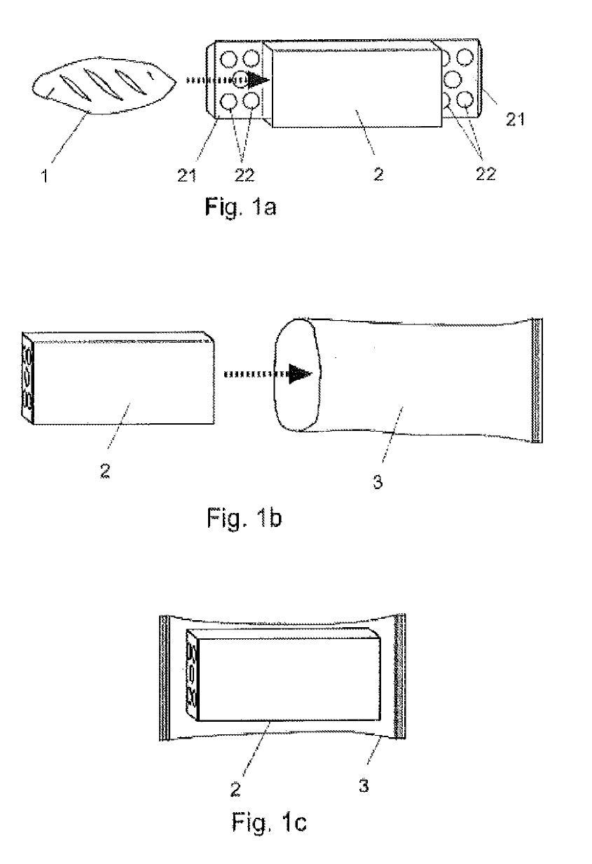

Turning now to FIG. 1a, after the pre-baked bread 1 has been prepared and pre-baked, it is placed into the carton 2 made of heat-resistant material, such as virgin cardboard. The carton 2 may be of quadrangular shape and include two foldable closures or lids 21 located at opposite sides of the carton 2. The lids 21 may include perforations 22 that permit circulation of air in and out of the carton 2.

The carton 2 containing the pre-baked bread 1 may then be introduced into the preserving bag or wrapping 3 as shown in FIG. 1b. The atmosphere within the bag 3 may be modified by introducing CO₂ to create a preservative atmosphere conducive to preservation of the pre-baked bread 1. The bag 3 may then be hermetically closed as shown in FIG. 1c such that the pre-baked bread 1 is enclosed within a preservative atmosphere. In a preferred embodiment, the bag 3 includes a barrier film made of polyester and polyethylene.

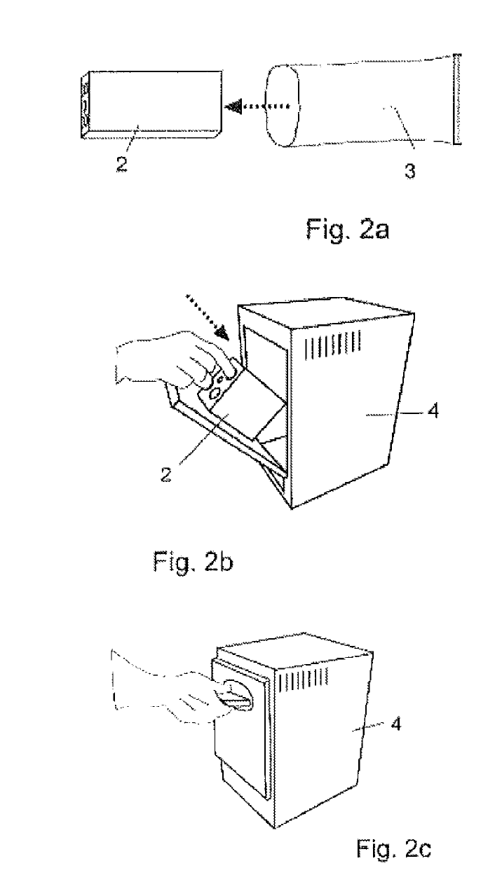

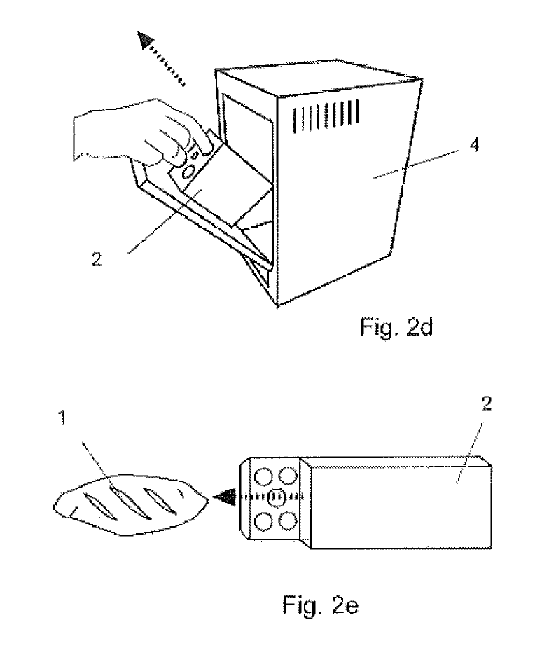

Referring to FIG. 2a, the regeneration phase involves first taking the carton 2 containing the pre-baked bread 1 out of the bag 3. Next, the carton 2 containing the pre-baked bread 1 may be placed into the regenerating oven 4, as shown in FIG. 2b. The oven 4 may be capable of automatically detecting the presence of the carton 2. The carton 2 and the pre-baked bread 1 are then heated at a temperature between about 100 degrees Celsius (about 212 Fahrenheit) to about 250 degrees Celsius (about 482 degrees Fahrenheit) for a period of time less than 7 minutes, as illustrated in FIG. 2c. The carton 2 containing the pre-baked bread 1 may then be removed from the oven 4 as illustrated in FIG. 2d. The pre-baked bread 1 may be consumed after removing it from the carton 2, as shown in FIG. 2e.

In an exemplary embodiment, the bread-regenerating oven 4 may comprise heating means using air convection and/or radiation; means for mechanical detection and recognition of the size and/or shape of the carton 2; and control means for determining time and heating temperature parameters depending on the size and/or shape of the carton 2 introduced in the bread-regenerating oven 4.

Thus, in an exemplary embodiment, when the carton 2 is introduced into the regenerating oven 4, a mechanism in the oven may detect the carton 2 and recognize its shape and/or size as corresponding to a pre-determined format that results in the automatic selection of heating temperature and time parameters suitable for regenerating the pre-baked bread 1 without input from the user. Other time and/or heating temperature parameters would be automatically selected based on different configurations of the carton 2.

While the preferred embodiments of the disclosure have been described, it should be understood that the disclosure is not so limited and modifications may be made without departing from the disclosure. The scope of the invention is defined by the appended claims, and all devices that come within the meaning of the claims, either literally or by equivalence, are intended to be embraced therein.

1. A method for preserving and regenerating pre-baked bread, comprising:
a preservation phase comprising:
enclosing the pre-baked bread in a receptacle capable of withstanding high temperatures;
enclosing the receptacle in an enclosure containing an atmosphere conducive to preservation of the pre-baked bread; and
a regeneration phase comprising:
removing the receptacle containing the pre-baked bread from the enclosure; and
heating the receptacle containing the pre-baked bread.

2. The method of claim 1, wherein the receptacle is comprised of cardboard.

3. The method of claim 1, wherein enclosing the pre-baked bread in an enclosure containing an atmosphere conducive to preservation comprises:
placing the receptacle into the enclosure;
introducing into the enclosure a gas conducive to the preservation of the pre-baked bread; and
hermetically sealing the enclosure.

4. The method of claim 3, wherein the enclosure is a plastic wrapper comprising a barrier film made of polyester and polyethylene.

5. The method of claim 3, wherein the gas is CO₂.

6. The method of claim 3, wherein the gas is a mixture of about 80% CO₂ and 20% Nitrogen.

7. The method of claim 1, wherein eating the receptacle containing the pre-baked bread comprises:
placing the receptacle containing the pre-baked bread in an oven; and
heating the receptacle containing the pre-baked bread at a temperature between about 100 degrees Celsius and about 250 degrees Celsius for less than 7 minutes.

8. A method for preserving and regenerating pre-baked bread, comprising:
enclosing the pre-baked bread in a receptacle capable of withstanding high temperatures;
placing the receptacle into an enclosure;
introducing into the enclosure a gas conducive to the preservation of the pre-baked bread; and
hermetically sealing the enclosure.

9. The method of claim 8, wherein the gas comprises at least 80% CO₂.

10. A system for the preservation and regeneration of pre-baked bread, comprising:
a packaging for pre-baked bread comprising:
a receptacle containing the pre-baked bread, the receptacle capable of withstanding high temperatures;
an enclosure hermetically enclosing the receptacle, the enclosure containing a gas conducive to preservation of the pre-baked bread;
a regenerating oven configured to:
receive the receptacle containing the pre-baked bread; and
heat the receptacle containing the pre-baked bread at a temperature between about 100 degrees Celsius and about 250 degrees Celsius.

11. The system of claim 10, wherein the receptacle is comprised of cardboard.

12. The system of claim 11, wherein the carton includes at least one perforation to allow circulation of air in and out of the carton.

13. The system of claim 12, wherein the carton is of quadrangular shape and the at least one perforation is located in at least one foldable lid.

14. The system of claim 10, wherein the regenerating oven is further configured to detect the introduction of the receptacle containing the pre-baked bread.

15. The system of claim 14, wherein the regenerating oven further comprises a controller configured to:
recognize a physical configuration of the receptacle;
select the temperature for heating the receptacle containing the pre-baked bread based on the physical configuration of the receptacle;
select a time for heating the receptacle containing the pre-baked bread based on the physical configuration of the receptacle; and
initiate heating of the receptacle containing the pre-baked bread at the selected temperature for the selected time.

16. The system of claim 10, wherein the regenerating oven is configured to heat the receptacle containing the pre-baked bread using convection.

17. The system of claim 10, wherein the regenerating oven is configured to heat the receptacle containing the pre-baked bread using radiation.

18. The system of claim 10, wherein the gas is CO₂.

19. The system of claim 10, wherein the gas is a mixture of about 80% CO₂ and 20% Nitrogen.

20. A packaging for preservation of pre-baked bread comprising:
a receptacle containing the pre-baked bread, the receptacle capable of withstanding high temperatures and including at least one perforation to allow circulation of air into and out of the receptacle;
an enclosure hermetically enclosing the receptacle, the enclosure containing a gas conducive to preservation of the pre-baked bread;
wherein the gas comprises at least 80% CO₂.
